(19) United States
(12) Patent Application Publication
(10) Pub. No.: US 2012/0187210 A1
(43) Pub. Date: Jul. 26, 2012

(54) Multi-headed Mobile Fogging System and Method

(76) Inventors: Jason Wheeler, (US); Terry Wheeler, (US)

(21) Appl. No.: 13/011,833

(22) Filed: Jan. 21, 2011

(51) Int. Cl. B05B 9/04

(52) U.S. Cl. 239/8; 239/373

(57) ABSTRACT

A fogging system and method are disclosed. Specifically, a fogging system comprising a compressed air source, an air tank, a container, and one or more nozzle assemblies. The air tank containing compressed air and the container containing a chemical. Wherein the compressed air source is fluidly connected to the air tank, which is fluidly connected to each of the nozzles assemblies. Further, the container is fluidly connected to each of the nozzle assemblies. Finally, the compressed air and the chemical are ejected from a nozzle output in the nozzle assemblies.

### BACKGROUND

This disclosure relates generally to a multi-headed mobile fogging device, system, and method for spraying and application of liquids and/or liquid-gas mixtures for a number of purposes such as: insect control/eradication, pesticide applications, medicinal or medical product spraying applications, including spraying antibiotics among livestock, chickens, pigs, etc. and antidotes for potential terrorist activities, herbicide applications, insecticide applications, paint applications, misting applications, cooling applications, water applications, fertilizer applications, horticultural applications, solid-stream applications, and application of cleaning/stripping/degreasing solutions for household and industrial uses. More particularly, the present disclosure relates to a cost effective, low-maintenance, and transportable liquid spraying system for the efficient application of liquid materials used to control insect populations, such as mosquito control products. For purposes of this disclosure, pesticides are discussed, and are an example of a fogging application. However, such discussion of pesticides is solely exemplary, and not limiting.

Systems for generating a fogging mist have evolved over the years. In one embodiment, a spraying device produces a precise degree of liquid droplet generation by combining a specified rate of regulated flow of liquid material with a regulated flow of high-pressure air in a nozzle assembly. Further, an air storage tank is coupled with a compressor to serve as a reservoir for excess airflow generation and to reduce air pulsation. However, the utility of said air storage tank is limited to reduction in air pulsation, rather than reducing wear and tear on said compressor. For example, said compressor, such as a direct drive compressor, would be required to provide compressed air as needed and therefore would be required to fluctuate to meet the needs of the fogging system.

In another embodiment, a spraying device comprises two components releasably attached to one another. A first component can comprise a frame assembly with an air tank and an air compressor. A second component can comprise a nozzle assembly and chemical reservoir. Said components can be used together or separately. However, such an embodiment does not accommodate a full range of spraying circumstances. Such an embodiment fails to accommodate a circumstance where said chemical reservoir is too large to be carried with said second component. Accordingly, said chemical reservoir is limited in size by the transportability of said second component.

Further, existing embodiments of spraying systems fail to accommodate multiple nozzle assemblies and a means to selectively control the output rate the same. Likewise, existing systems make no provision for attaching to a vehicle's standard trailer hitch or the like. Still further, existing systems do not provide for adjustable articulating Venturi nozzles, nor the capability to automatically adjust the pitch and height of same. Further, existing systems do not provide a means to regulate chemical flow by controlled valves, capable of variable flow control based upon the relative speed of the system. Still further, existing systems do not provide for detachable nozzles assemblies capable of being used apart from the core components of the system.

As such it would be useful to have an improved multi-headed mobile fogging system and method.

### SUMMARY

A fogging system comprising a compressed air source, an air tank, a container, and one or more nozzle assemblies is disclosed. The air tank containing compressed air and the container containing a chemical. Wherein the compressed air source is fluidly connected to the air tank, which is fluidly connected to each of the nozzles assemblies. Further, the container is fluidly connected to each of the nozzle assemblies. Finally, the compressed air and the chemical are ejected from a nozzle output in the nozzle assemblies.

### BRIEF DESCRIPTION OF THE DRAWINGS

FIG. 1 illustrates an upper front view of a multi-headed mobile fogging system.

FIG. 2 illustrates an upper first side view of multi-headed mobile fogging system.

FIG. 3 illustrates an isolated view of one or more legs.

FIG. 4 illustrates a lower rear view of multi-headed mobile fogging system.

FIG. 5A illustrates an upper second side view of multi-headed mobile fogging system.

FIG. 5B illustrates a detailed view of a battery, a controller, and one or more solenoid valves.

FIG. 5C illustrates a detailed view of solenoid valves and one or more flow regulator assemblies.

FIG. 6A, FIG. 6B and FIG. 6C illustrate multiple isolated views of an engine, a compressor, and an air tank, connected.

FIGS. 7A and 7B illustrate an overview and detailed view of one or more pressure regulators.

FIG. 8A illustrates a first boom and a first assembly.

FIG. 8B illustrates first boom with a plurality of nozzle assemblies.

### DETAILED DESCRIPTION

Described herein is a multi-headed mobile fogging system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

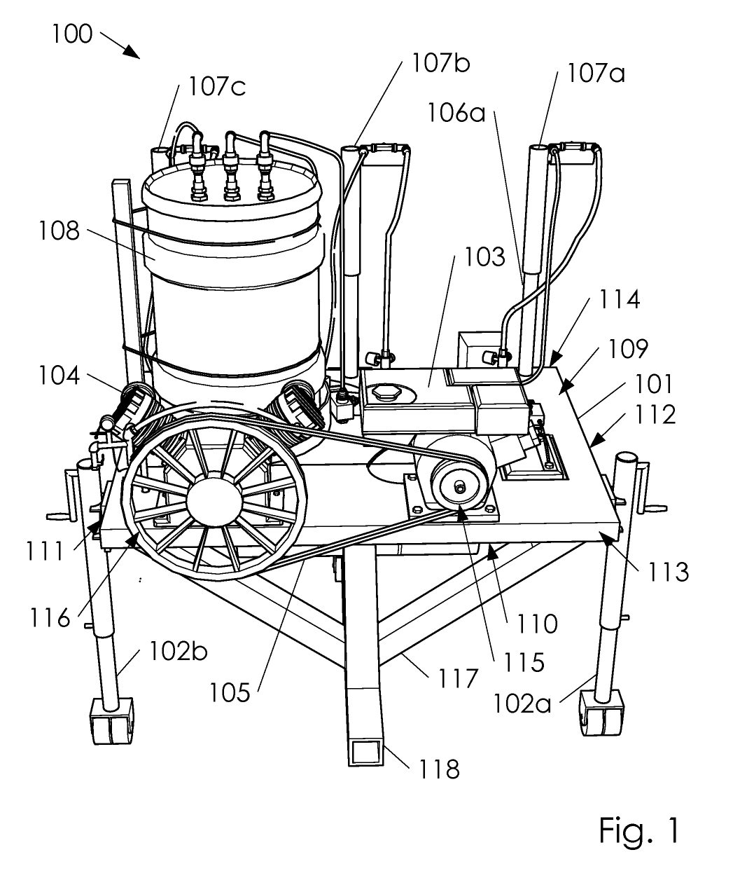

FIG. 1 illustrates an upper front view of a multi-headed mobile fogging system 100. Multi-headed mobile fogging system 100 can comprise a base 101, one or more legs 102, an engine 103, an air compressor 104, a belt 105, one or more booms 106, one or more nozzle assemblies 107, and a container 108. Base 101 can comprise a base top 109, a base bottom 110, a first side 111, a second side 112, a third side 113, and a fourth side 114. Booms 106 can comprise a first boom 106a, a second boom 106b, and a third boom 106c. Nozzle assemblies 107 can comprise a first assembly 107a, a second assembly 107b, and a third assembly 107c. In one embodiment, engine 103, air compressor 104, booms 106, and container 108 can be attached to base top 109.

Engine 103 can comprise a drive wheel 115. Air compressor 104 can comprise a compressor wheel 116. In one embodiment, engine 103 can turn drive wheel 115, turning belt 105, thereby turning compressor wheel 116, and thereby providing a power source to air compressor 104. In another embodiment, a non-gasoline engine, such as an electric motor, can drive belt 105. In one embodiment, air compressor 104 can provide pressurized air for use by multi-headed mobile fogging system 100.

In one embodiment, air compressor 104 can be a direct drive compressor, such as an electrical or gas powered air compressor. In one embodiment, said direct drive air compressor can replace the combination of engine 103, belt 105, and air compressor 104.

Container 108 can contain a chemical 119 for delivery by multi-headed mobile fogging system 100. In one embodiment, chemical 119 can comprise an oil- or water-based chemical, such as pesticides, fertilizer, or defoliant. In another embodiment, chemical 119 can comprise any chemical that needs to be distributed by multi-headed mobile fogging system 100.

Legs 102 can comprise a first leg 102a, a second leg 102b, and a third leg 102c. In one embodiment, first leg 102a can attach to second side 112, second leg 102b can attach to first side 111, and third leg 102c can attach to fourth side 114. In one embodiment, multi-headed mobile fogging system 100 can further comprise one or more supports 117 and a hitch-connector 118.

In one embodiment, supports 117 can attach to base bottom 110. Further, in one embodiment, hitch-connector 118 can attach to supports 117. In another embodiment, hitch-connector 118 can attach directly to base 101 instead of supports 117. In one embodiment, hitch-connector 118 can be used for attaching multi-headed mobile fogging system 100 to a wide variety of vehicles. For example, in one embodiment, hitch-connector 118 can connect to a standard receiver-type trailer hitch with a portion that can mount to the frame of the vehicle that has a rearward facing opening that accepts ball mounts, cargo carriers, or other hitch mounted accessories. In another embodiment, hitch-connector 118 can be configured to attach to a tractor. In another embodiment, multi-headed mobile fogging system 100 can be carried in a bed of a truck, bypassing the need for hitch-connector 118. In another embodiment, multi-headed mobile fogging system 100 can further comprise a removable axel and wheel assembly, wherein multi-headed mobile fogging system 100 can be attached and dragged behind a vehicle, such as a car, truck, tractor, all-terrain vehicle, or the like.

In one embodiment, a guard can be mounted around belt 105, drive wheel 115, and compressor wheel 116. For example, in one embodiment, said guard can serve to protect users of multi-headed mobile fogging system 100 from injury due to accidental interaction with drive wheel 115 or compressor wheel 116. In one embodiment, said guard can be removed for maintenance if necessary.

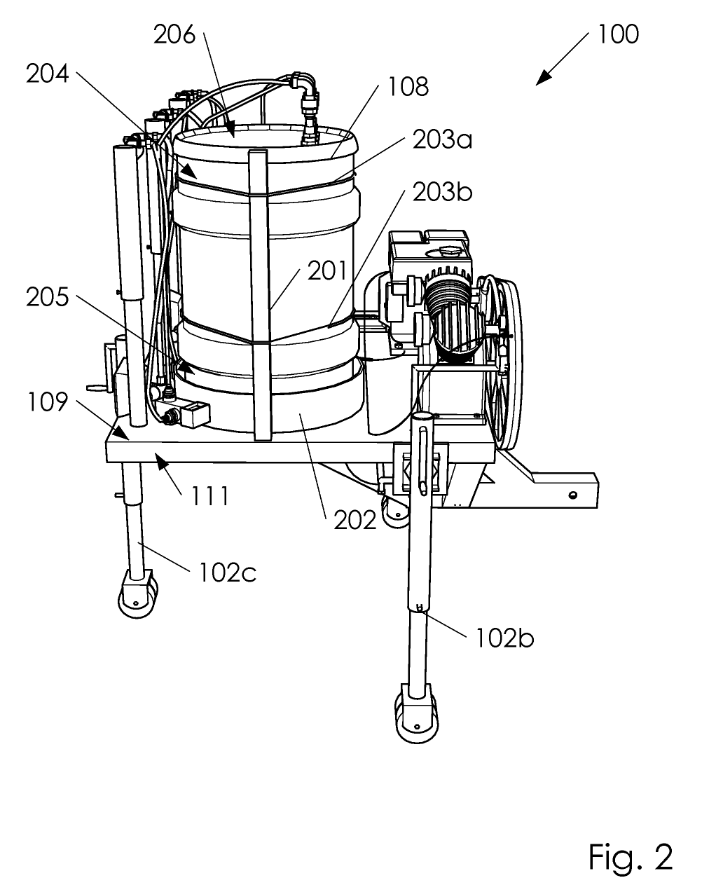

FIG. 2 illustrates an upper first side view of multi-headed mobile fogging system 100. Multi-headed mobile fogging system 100 can further comprise a first container support 201, a cylindrical container support 202, and one or more straps 203. Straps 203 can comprise a first strap 203a and a second strap 203b. Container 108 can comprise an upper portion 204, a lower portion 205 and a top 206. In one embodiment, container 108 can be secured to multi-headed mobile fogging system 100 by a combination of first container support 201, cylindrical container support 202, and/or straps 203. In one embodiment, first container support 201 can comprise a ridged material attached to base top 109 and extending to a height substantially equal to the height of container 108. In one embodiment, cylindrical container support 202 can comprise a solid ring made of a ridged material capable of supporting lower portion 205. In one embodiment, the internal circumference of cylindrical container support 202 is substantially equal to or larger than the external circumference of lower portion 205. In one embodiment, straps 203 can be wrapped around container 108 and first container support 201. For example, in one embodiment, first strap 203a can wrap around upper portion 204 and first container support 201, and second strap 203b can wrap around lower portion 205 and first container support 201. In one embodiment, container 108 can be exchange for a replacement container by releasing straps 203, removing container 108, inserting a similar container into cylindrical container support 202, and tying straps 203 around the new container and first container support 201.

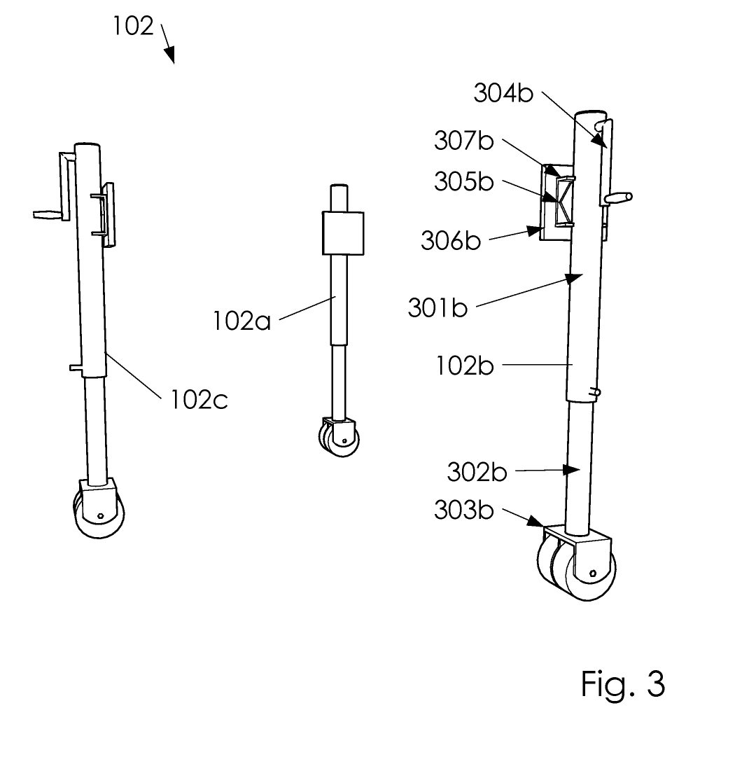

FIG. 3 illustrates an isolated view of one or more legs 102. Each of legs 102 can comprise a first segment 301, a second segment 302, a wheel assembly 303, a crank 304, a rotating bracket 305, a leg mount 306, and a pin 307. In one embodiment, second segment 302 can telescope from within first segment 301 as crank 304 is turned. In one embodiment, each of legs 102 can be removed from multi-headed mobile fogging system 100 by pulling pin 307 and lifting legs 102 out and away from multi-headed mobile fogging system 100.

In one embodiment, leg mount 306b can attach first side 111 to rotating bracket 305b, and rotating bracket 305b can attach first portion 301b to leg mount 306b. In one embodiment, first portion 301b and wheel assembly 303b are attached at opposite ends of second portion 302b. In one embodiment, wheel assembly 303b can pivot freely about the base of second portion 302b to allow second leg 102b to change direction easily.

In one embodiment, rotating bracket 305b can allow legs 102 to rotate and lock into at a plurality of positions. For example, in one embodiment, second leg 102b can have a first legs position substantially perpendicular to base bottom 110 and a second legs position substantially parallel with base bottom 110. While in first legs position, multi-headed mobile fogging system 100 can be easily rolled around on wheel assemblies 303. Further, while in first legs position, the height of multi-headed mobile fogging system 100 can be adjusted by turning cranks 304 which can be internally attached to a screw thread to apply a high linear force. For example, in one embodiment, a user of multi-headed mobile fogging system 100 in first legs position can roll hitch-connector 118 near to a vehicle's receiver-type trailer hitch, readjust the height of legs 102 with cranks 304, attach multi-headed mobile fogging system 100 to a vehicle, and rotate legs 102 up into second legs position. Accordingly, multi-headed mobile fogging system 100 is capable of simplifying common configuration tasks. Likewise, while in second legs position, multi-headed mobile fogging system 100 can be attached to a flat surface, such as a bed of a pickup truck. In one embodiment, where legs 102 have been rotated into said second legs position, legs 102 can be pinned into base to secure them up and out of the way. In another embodiment, where legs 102 are in second legs position, and the weight of multi-headed mobile fogging system 100 has been taken off of legs 102, legs 102 can be detached from multi-headed mobile fogging system 100.

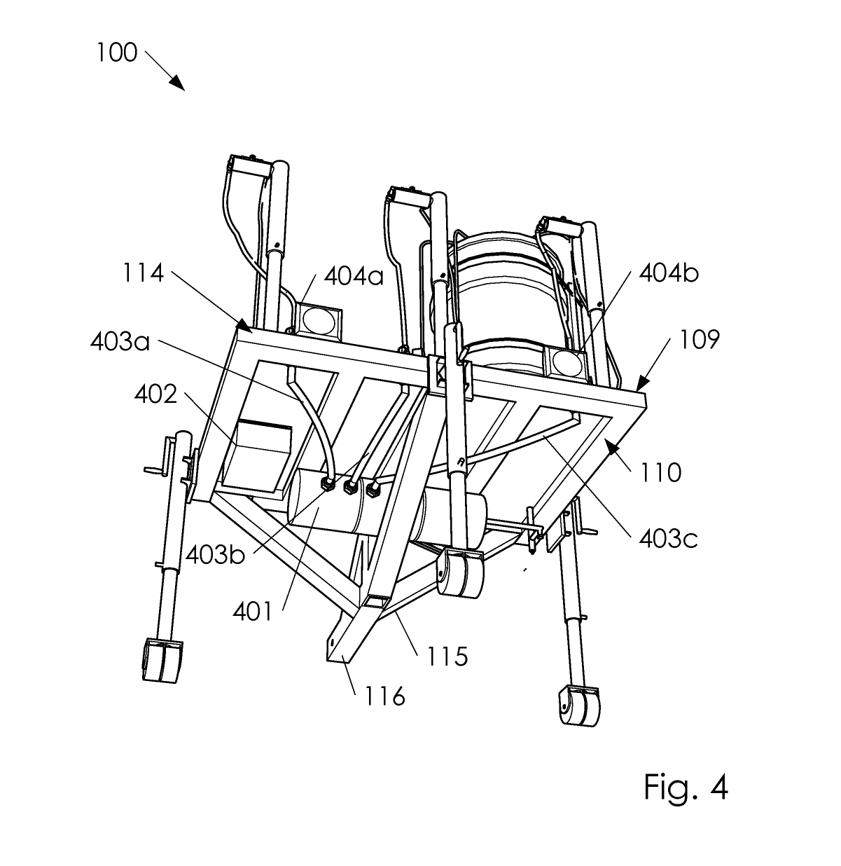

FIG. 4 illustrates a lower rear view of multi-headed mobile fogging system 100. Multi-headed mobile fogging system 100 can further comprise an air tank 401, a battery box 402, one or more pressurized hoses 403, and one or more taillights 404. Pressurized hoses 403 can comprise a first pressurized hose 403a, a second pressurized hose 403b, and a third pressurized hose 403c. Taillights 404 can comprise a first taillight 404a, and a second taillight 404b. In one embodiment, battery box 402 can be substantially in the form of a rectangular box and extend below base bottom 110. In one embodiment, air tank 401 can be attached to base bottom 110. In one embodiment, air tank 401 can be attached and protected between base bottom 110 and supports 117. In one embodiment, air tank 401 can have three outputs to provide pressurized air to pressurized hoses 403. In one embodiment, pressurized hoses 403 can extend from air tank 401, through holes in base 101, and attach to components on base top 109. In one embodiment, first taillight 404a and second taillight 404b can be incorporated into a breaking and signaling system of a vehicle which is attached to multi-headed mobile fogging system 100.

In another embodiment, air tank 401 can be capable of replacing base 101. For example, in one embodiment, air tank 401 can be substantially in the form of a rectangular platform, capable of supporting the components of multi-headed mobile fogging system 100.

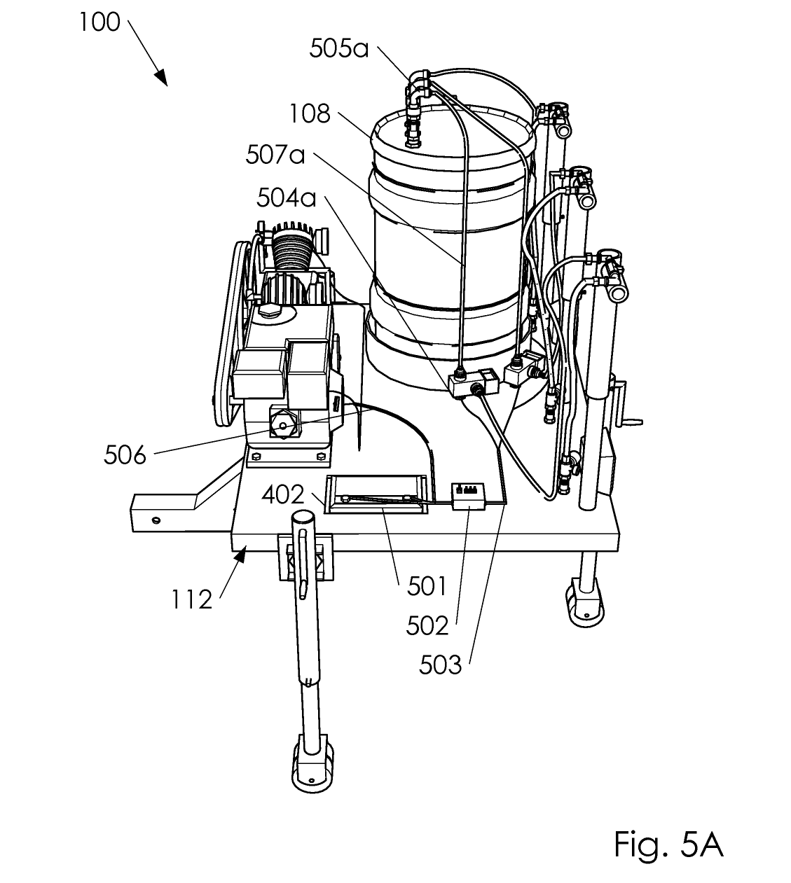

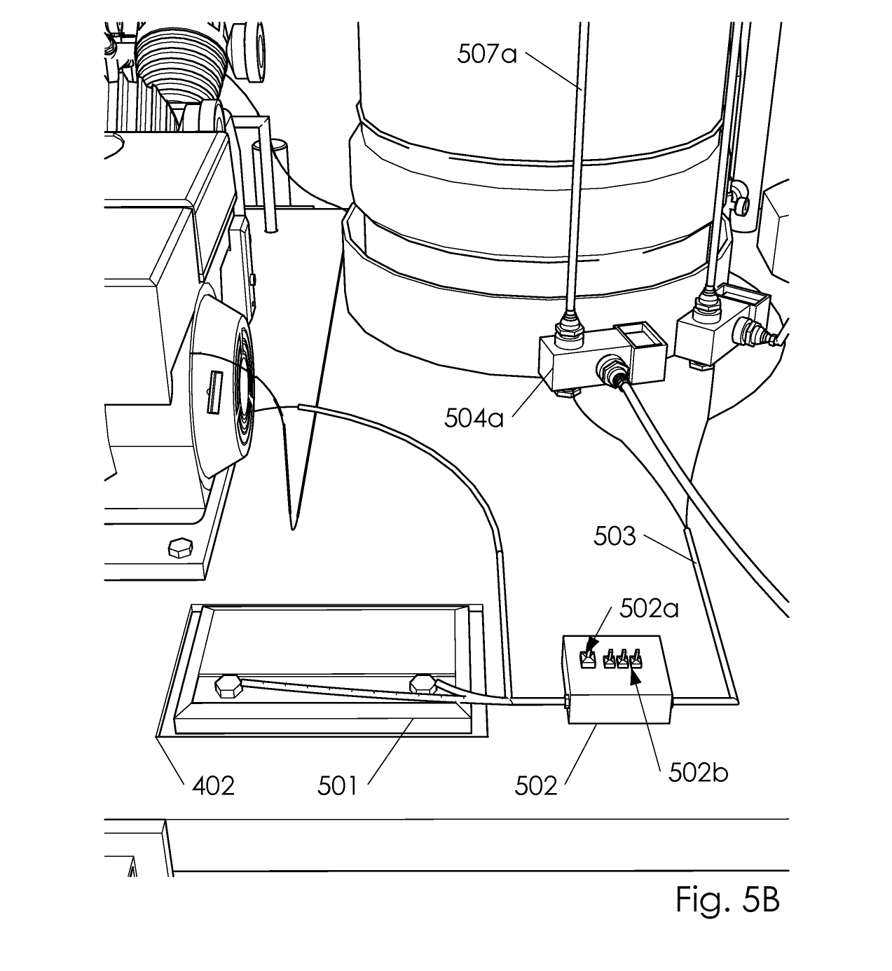

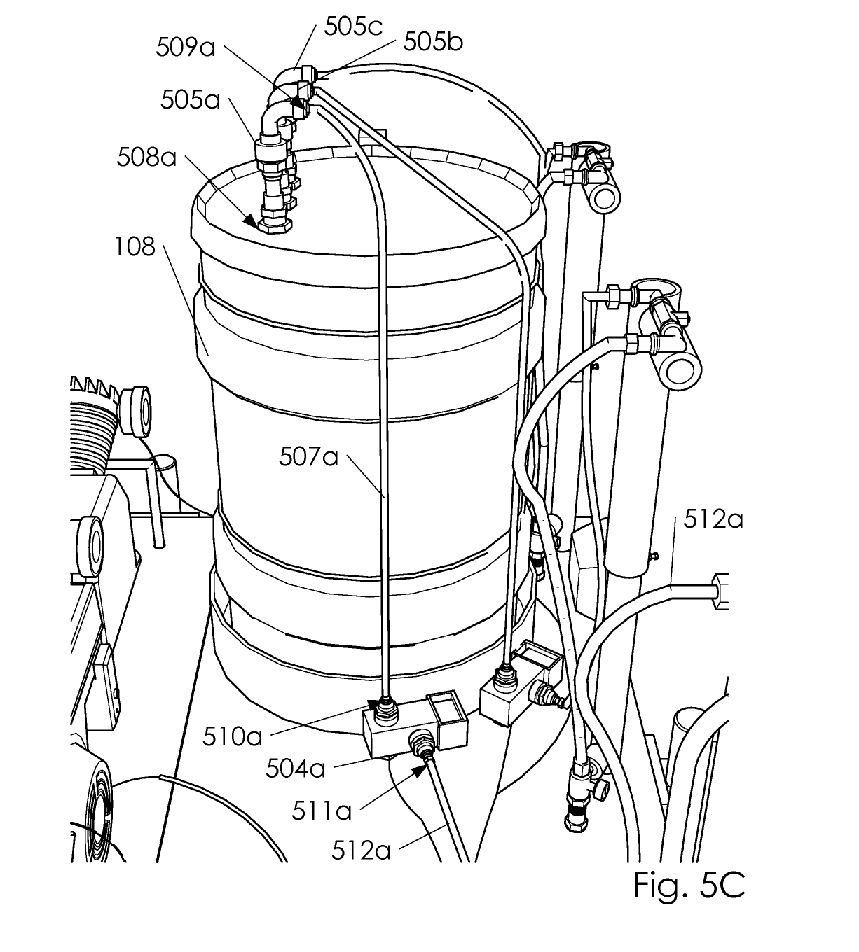

FIG. 5A illustrates an upper second side view of multi-headed mobile fogging system 100. Multi-headed mobile fogging system 100 can comprise a battery 501, a controller 502, one or more controller wires 503, one or more solenoid valves 504, one or more flow regulator assemblies 505, one or more power wires 506, and one or more chemical lines 507. In one embodiment, a hole can be cut in base 101 large enough to hold battery box 402, wherein the top of battery box 402 is open and capable of holding battery 501.

FIG. 5B illustrates a detailed view of battery 501, controller 502, and solenoid valves 504. Solenoid valves 504 can comprise a first solenoid valve 504a, a second solenoid valve 504b, and a third solenoid valve 504c. Chemical lines 507 can comprise a first line 507a, a second line 507b, and a third line 507c. In one embodiment, battery 501 can be secured inside of battery box 402. In another embodiment, controller 502 can be attached to a power source, such as battery 501. In one embodiment, controller 502 can comprise a master switch 502a to control the on/off status of solenoid valves 504 by connecting controller 502 to solenoid valves 504 by controller wires 503. Further, in one embodiment, controller 502 can comprise one or more individual switches 502b to control each of solenoid valves 504.

Multi-headed mobile fogging system 100 can be reconfigured with multiple electrical system configurations. For example, both engine 103 and air compressor 104 can each comprise an electrical generator module. In one embodiment, said electrical generator module can provide a power source for the general utility of users of multi-headed mobile fogging system 100. In one embodiment, said electrical generator module can provide power to recharge battery 501. Further, in one embodiment, said breaking and signaling system of a vehicle attached to taillights 404. In another embodiment, said breaking and signaling system can further provide an additional power source to multi-headed mobile fogging system 100.

Flow regulator assemblies 505 can each further comprise one or more filters 513 and one or more flow restrictor plates 514. In one embodiment, flow regulator assemblies 505 can keep many contaminants from entering chemical lines 507 by filters 513. In one embodiment, flow regulator assemblies 505 and flow restrictor plates 514 can regulate the maximum rate at which chemical 119 is feed from within container 108 into solenoid valves 504. For example, in one embodiment, flow restrictor plates 514 with variable settings are placed inside of flow regulator assemblies 505 between container 108 and chemical lines 507.

FIG. 5C illustrates a detailed view of solenoid valves 504 and flow regulator assemblies 505. Multi-headed mobile fogging system 100 can further comprise one or more chemical lines 512. Flow regulator assemblies 505 can comprise a first assembly 505a, a second assembly 505b, and a third assembly 505c. Flow regulator assemblies 505 can further comprise an input 508 and an output 509. Solenoid valves can comprise an input 510 and an output 511. In one embodiment, solenoid valves 504 can be switched between an on position and an off position by a signal from controller 502. In one embodiment, output 509 can be attached to input 510 by chemical lines 507. In one embodiment, where solenoid valves 504 are in said on position, chemical 119 can move freely through solenoid valves 504. Likewise, in another embodiment, where solenoid valves 504 are in said off position, chemical 119 can no longer move freely through solenoid valves 504.

In another embodiment, controller 502 can provide a variable voltage output rather than an on/off (discrete) signal. In such an embodiment, solenoid valves 504 can be variably controlled to provide variations in flow coming into solenoid valves 504. Further, in another embodiment, the variable signal to solenoid valves 504 can be controlled by the speed at which multi-headed mobile fogging system 100 is traveling in order to adjust chemical output based upon the output per distance travelled.

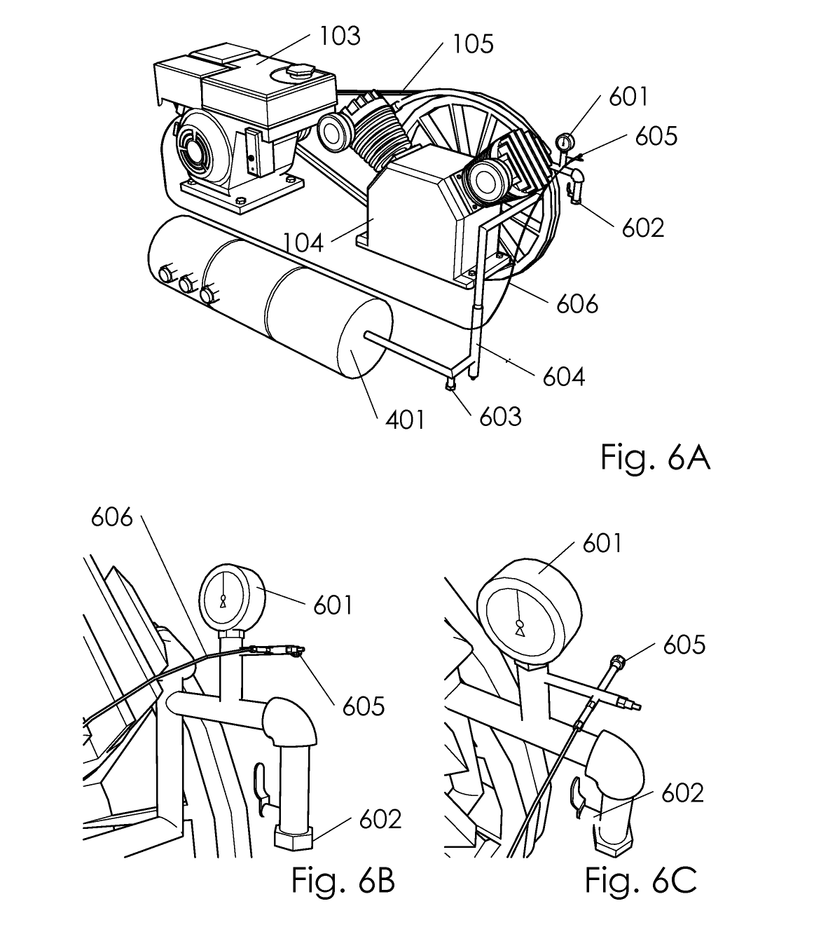

FIG. 6A, FIG. 6B and FIG. 6C illustrate multiple isolated views of engine 103, air compressor 104, and air tank 401, connected. Multi-headed mobile fogging system 100 can comprise a pressure gauge 601, a manual release valve assembly 602, a safety dump valve 603, a compressor line 604, an operational valve 605, and a cutoff line 606. In one embodiment, air compressor 104 can pump air into air tank 401. For example, in one embodiment, air compressor 104 can be fluidly attached to air tank 401 by compressor line 604.

In one embodiment, one or more valves and/or gauges can be used to regulate air pressure in air tank 401 and compressor line 604. For example, in one embodiment, pressure gauge 601, manual release valve assembly 602, safety dump valve 603, and/or operational valve 605 can regulate air pressure in compressor line 604. In one embodiment, pressure gauge 601 can be attached to compressor line 604 to determine the pressure in compressor line 604. In another embodiment, when pressure reaches or surpasses a desired operational air pressure level, operational valve 605 can open to release excess pressure in compressor line 604. For example, in one embodiment, where said operational air pressure level is 150 psi, operational valve 605 can be set to open and release excess pressure when internal pressure reaches 118 psi. In one embodiment, where pressure in compressor line 604 or air tank 401 approach an undesired or unsafe level, safety dump valve 603 can open to partially or fully normalize the pressure inside and out of multi-headed mobile fogging system 100. For example, in one embodiment, where air tank 401 is only safe for air pressures up to 200 psi, safety dump valve 603 may be set to open when air pressure reaches 175 psi.

In one embodiment, prior to starting engine 103, it may be advantageous to minimize resistance in air compressor 104 by dropping the starting internal pressure in compressor line 604. In one embodiment, manual release valve assembly 602 can be used to substantially normalize the internal and external pressures of multi-headed mobile fogging system 100. Accordingly, manual release valve assembly 602 can be opened to release air until internal pressure drops to an appropriate starting initial pressure before closing manual release valve assembly 602 once again. In another embodiment, cutoff line 606 can be attached to compressor line 604 at one end and engine 103 at the other end. In such an embodiment, cutoff line 606 can be capable of disconnecting the starter of engine 103 when said starting initial pressure level is too high. Accordingly, multi-headed mobile fogging system 100 can be configured to not start when pressure in compressor line 604 is at an undesired level.

Keeping a steadily replenished reservoir of pressurized air in air tank 401 for use by multi-headed mobile fogging system 100, rather than producing compressed air at the time of consumption, can reduce wear and tear on multi-headed mobile fogging system 100 and provide a consistent fog output. For example, without air tank 401 fluidly connected between air compressor 104 and the point of consumption, the pressurized air source would need to fluctuate as the need for compressed air fluctuates. That is, the workload is directly related to air pressure demand. Accordingly, lacking a steadily replenished reservoir of pressurized air minimizes wear and tear on multi-headed mobile fogging system 100. Further, by supplying compressed air to the point of consumption from a steadily replenished reservoir, rather than directly from air compressor 104, said compressed air not pulsate based on the output of air compressor 104.

Further, separating the workload on engine 103 from the workload on air compressor 104 serves to minimize the wear and tear on engine 103. For example, in one embodiment, engine 103 can run at an idle and nonetheless produce enough energy to keep air compressor 104 running within an operating threshold for multi-headed mobile fogging system 100. In one embodiment, where air compressor 104 produces too much compressed air, operational valve 605 can automatically open to reduce air pressure in air tank 401. Accordingly, wear and tear on engine 103 is minimized since it can run at a steady rate in such an embodiment.

In one embodiment, air compressor 104 can provide compressed air for tasks not strictly related to the core uses of multi-headed mobile fogging system 100. For example, in one embodiment, pneumatic tools can acquire a compressed air source from air compressor 104, compressor line 604, or air tank 401. In one embodiment, pneumatic tools can comprise an air impact wrench, an airbrush, a jackhammer, a pneumatic grinder, a pneumatic sander, a pneumatic drill, a pneumatic screwdriver, a pneumatic paint gun, a pneumatic nail gun, or the like.

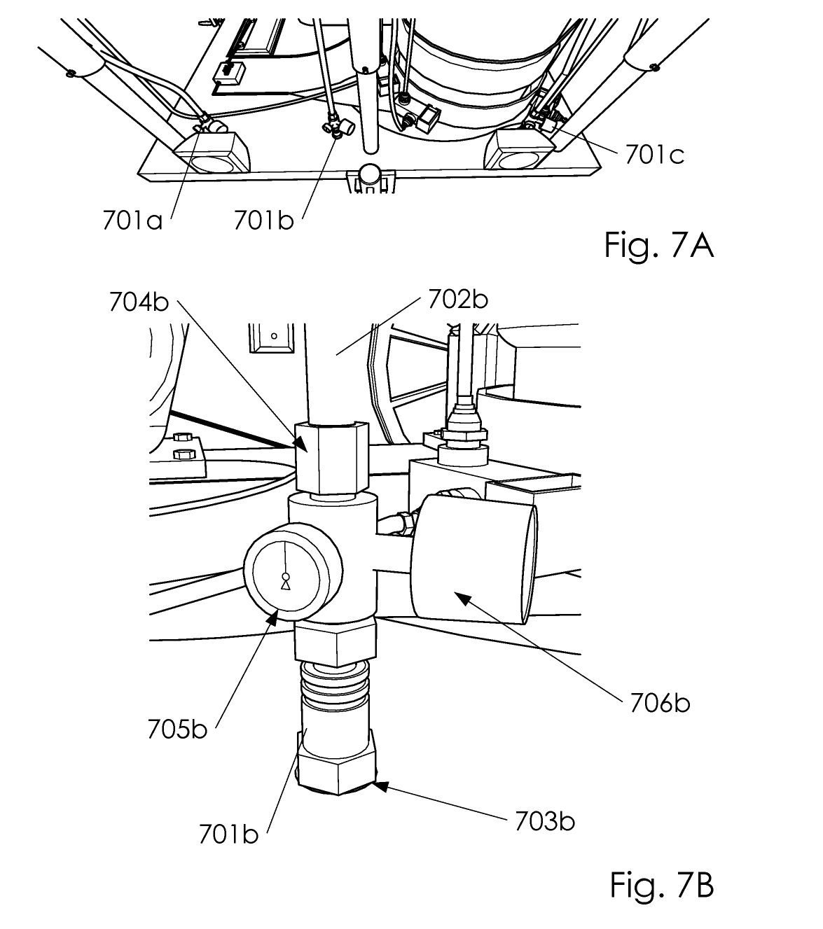

FIGS. 7A and 7B illustrate an overview and detailed view of one or more pressure regulators 701. Multi-headed mobile fogging system 100 can further comprise pressure regulators 701 and one or more pressure hoses 702. Pressure regulators 701 can comprise a first regulator 701a, a second regulator 701b, and a third regulator 701c. Each of pressure regulators 701 can comprise an input 703, an output 704, a gauge 705, and a regulator knob 706. For example, in one embodiment, second regulator 701b can comprise an input 703b, an output 704b, a gauge 705b, and a regulator knob 706b, as show in FIG. 7. In one embodiment, pressurized hoses 403 can each respectively attach to input 703. Accordingly, in one embodiment, pressurized air from within air tank 401 can be feed into pressure regulators 701. In one embodiment, pressure regulators 701 can control air pressure provided to outputs 704. In another embodiment, pressure regulators 701 can variably control air pressure provided to output 704 by variably adjusting regulator knobs 706. Further, in one embodiment, gauges 705 can provide an indicator as to the pressure of air released to output 704. In one embodiment, pressure hoses 702 can be attached to outputs 704. In one embodiment, pressure regulator 701 can be adjusted to ensure proper operating pressure is provided to multi-headed mobile fogging system 100.

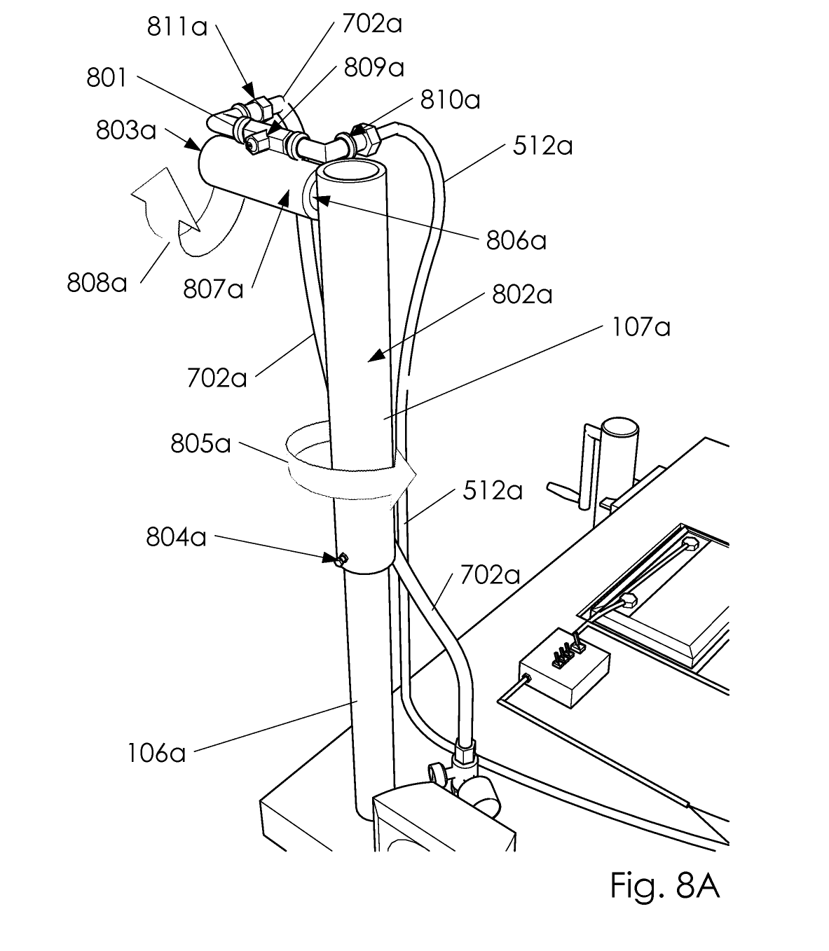

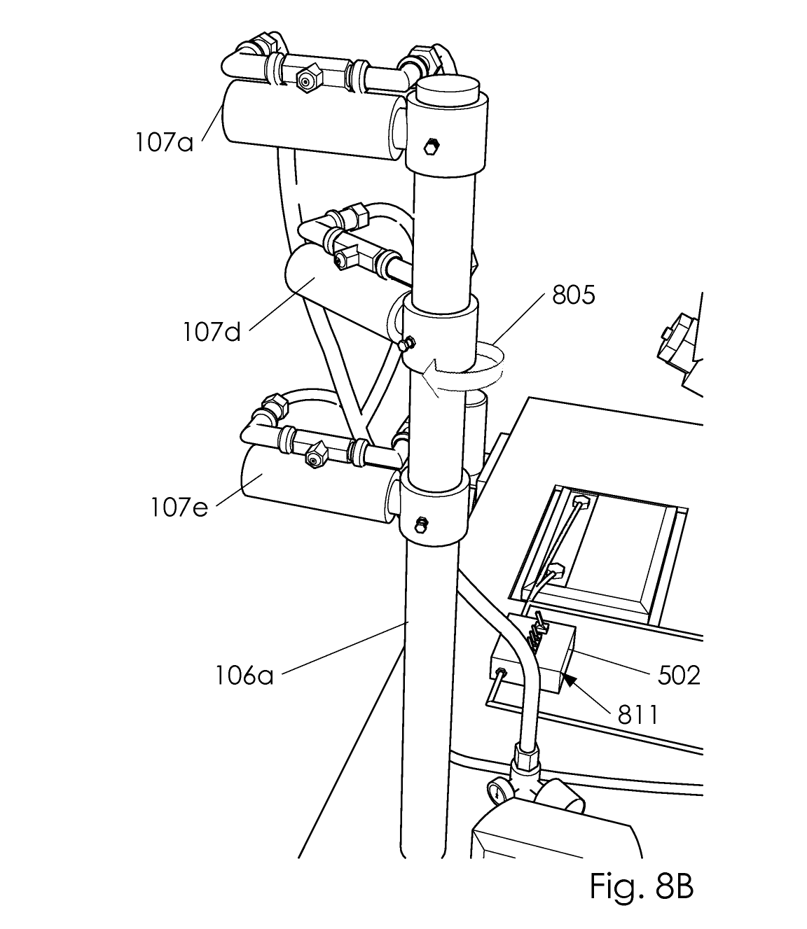

FIG. 8A illustrates first boom 106a and first assembly 107a. Nozzle assemblies 107 can each comprise a spray nozzle assembly 801, a horizontally rotating portion 802, a vertically rotating portion 803, and a pin 804. For example, first assembly 107a can comprise a spray nozzle assembly 801a, a horizontally rotating portion 802a, and a vertically rotating portion 803a.

In one embodiment, horizontally rotating portions 802 can each be adjusted upon a horizontal rotation 805 about booms 106 by loosening pin 804, adjusting horizontally rotating portion 802 to the desired rotary position, and tightening pin 804. Vertically rotating portion 803 can comprise an interior portion 806 and an exterior portion 807. In one embodiment, interior portion 806 can be attached to horizontally rotating portion 802 and exterior portion 807 can be adjusted upon a vertical rotation 808 about interior portion 806. Further, in one embodiment, spray nozzle assembly 801 can be attached to exterior portion 807 whereupon it can be reconfigured to have an uninhibited horizontal rotation 805 and uninhibited vertical rotation 808.

Spray nozzle assembly 801 can comprise a Venturi nozzle 809, a first input 810, and a second input 811. In one embodiment, Venturi nozzle 809 can be a standard Venturi nozzle as known in the art. In one embodiment, chemical lines 512 can be attached to first input 810 and pressure hoses 702 can be attached to second input 811. Accordingly, in one embodiment, Venturi nozzle 809 will produce a fog, a fine mist, or a spray containing chemical 119.

FIG. 8B illustrates first boom 106a with a plurality of nozzle assemblies 107. Nozzle assemblies 107 can further comprise a fourth assembly 107d and a fifth assembly 107e. In one embodiment, a plurality of nozzle assemblies 107 can be attached to one boom 106. For example, in one embodiment, first assembly 107a, fourth assembly 107d and fifth assembly 107e can all be attached to 106a. In one embodiment, each nozzle assembly 107 can be adjusted to a relative height on boom 106 by loosening pin 804, sliding said horizontally rotating portion 802 on boom 106 to the desired height, and tightening pin 804.

In one embodiment, multi-headed mobile fogging system 100 can have a plurality of nozzle assemblies 107 pointing in different directions in order to provide more complete coverage as multi-headed mobile fogging system 100 is engaged. For example, in one embodiment, a plurality of nozzle assemblies 107 can be adjusted to spray in a different direction and at different relative heights on a single boom 106, as in FIG. 8b. In one embodiment, the direction and relative heights of nozzle assemblies 107 can be controlled programmatically by using controller 502 and one or more adjustable servo mechanisms to change their horizontal rotation 805, vertical rotation 808, and/or relative height.

In one embodiment, multi-headed mobile fogging system 100 can be used apart from a vehicle. For example, in one embodiment, booms 106 can detach from base 101 and be carried to a location inconvenient for a vehicle or the entire multi-headed mobile fogging system 100. For example, in one embodiment, where a sewer needs to be treated for sanitation or pest control purposes, fogging nozzle assemblies 107 can be taken to a treatment location by releasing booms 106 from base 101, carrying booms 106 and fogging nozzle assemblies 107 to the treatment location, and running multi-headed mobile fogging system 100 at the treatment location. In such an embodiment, chemical lines 512 and pressure hoses 702 will require sufficient length to reach the treatment location. In some embodiments, the distance between the treatment location and multi-headed mobile fogging system 100 may be too great for the suction in chemical lines 512 to deliver chemical 119 to spray nozzle assembly 801. In such an embodiment, a fluid pump can be fluidly connected between container 108 and fogging nozzle assemblies 107 to provide sufficient pressure to deliver chemical 119 to fogging nozzle assemblies 107.

Controller 502 can comprise a variable speed controller module 811. In one embodiment, variable speed controller module 811 can be capable of collecting the relative speed of multi-headed mobile fogging system 100, generating a chemical distribution rate signal 812, and sending that signal down controller wires 503. In one embodiment, variable speed controller module 811 collects the relative speed of multi-headed mobile fogging system 100 with a Global Positioning System (“GPS”). Wherein said GPS can be capable of calculating its position by precisely timing the signals sent by GPS satellites, each continually transmitting messages that include time of transmission, orbital information, and the general system health and rough orbits of all GPS satellites. In another embodiment, variable speed controller module 811 collects the relative speed of multi-headed mobile fogging system 100 from a signal sent from a vehicle it is connected to. In yet another embodiment, variable speed controller module 811 collects the relative speed of multi-headed mobile fogging system 100 from a radar or laser sensor capable of measuring relative speeds.

In one embodiment, multi-headed mobile fogging system 100 can distribute a variable payload out of Venturi nozzles 809 based upon chemical distribution rate signal 812. For example, in one embodiment, variable speed controller module 811 can calculate a distribution rate based upon the relative speed of multi-headed mobile fogging system 100 and other variables (such as environmental variables, chemical type and density, etc.), send chemical distribution rate signal 812 to solenoid valves 504 which, in turn, adjust the volume of chemical 119 distributed from Venturi nozzles 809. Alternatively, in one embodiment, where said variable fluid pump is used rather than solenoid valves 504, chemical distribution rate signal 812 can be used to adjust the volume pumped from container 108 to Venturi nozzles 809 by said variable fluid pump.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive, For example, the above-described embodiments may be used in combination with each other, Many other embodiments will be apparent to those of skill in the art upon reviewing the above description, The scope of the invention should, therefore, be determined with reference to the appended claims, along with the full scope of equivalents to which such claims are entitled, In the appended claims, the terms “including” and “in which” are used as the plain-English equivalents of the respective terms “comprising” and “wherein.”

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A fogging system comprising
a compressed air source,
an air tank containing compressed air,
a container containing a chemical, and
one or more nozzle assemblies each having a nozzle having a first input, a second input, and a nozzle output;
wherein
said compressed air source is fluidly connected to said air tank by one of one or more compressor lines,
said air tank is fluidly connected to each of said first inputs of said nozzles by one of one or more pressure hoses,
said container is fluidly connected to each of said second inputs of said nozzles by one of one or more chemical lines, and
said compressed air and said chemical are ejected from said nozzle output.

2. The fogging system of claim 1 wherein said air source comprises an air compressor.

3. The fogging system of claim 1 further comprising
an air compressor having a compressor wheel,
a power source, and
a belt connecting said compressor wheel to said power source.

4. The fogging system of claim 3 wherein said power source comprises an internal combustion engine having a drive wheel connected to and turning said belt.

5. The fogging system of claim 3 wherein said power source comprises an electric motor having a drive wheel connected to and turning said belt.

6. The fogging system of claim 1 wherein said compressor line can comprise a manual release valve capable of releasing said compressed air prior to starting said fogging system.

7. The fogging system of claim 1 wherein said compressor line further comprises one or more automatic release valves capable of opening when said compressed air reaches an undesired pressure level.

8. The fogging system of claim 1 wherein said nozzle is a Venturi nozzle.

9. The fogging system of claim 1 further comprising one or more solenoid valves fluidly connected between said nozzle assemblies and said container in said chemical lines and a controller controlling said solenoid valves.

10. The fogging system of claim 9 wherein:
said controller further comprises one or more switches;
said switches comprise a master switch and one or more individual switches;
said master switch controls all of said solenoid valves;
each of said individual switches control one of said solenoid valves; and
said switches comprising a plurality of control positions capable of setting each of said solenoid valves to an openness position.

11. The fogging system of claim 1 wherein said pressure hoses each comprises one or more pressure regulators.

12. The fogging system of claim 11 wherein said pressure regulators comprise a gauge and a regulator knob capable of variably adjusting the volume of said compressed air passing through each of said pressure regulators.

13. The fogging system of claim 1 further comprising
a base having a first side, a second side, a front and a back, and
one or more booms each having a first end and a second end;
wherein
said compressed air source, said air tank, said container and said first end of said booms are attached to said base, and
one or more of said nozzle assemblies are attached to said second end of said booms.

14. The fogging system of claim 13 wherein said nozzle assemblies, each having a horizontally rotating portion and a vertically rotating portion, wherein said nozzle assemblies are capable of rotating substantially left and right on said horizontal rotating portion and substantially up and down on said vertical rotating portion.

15. The fogging system of claim 14 wherein
each of said horizontally rotating portions are attached to said booms and capable of adjustably rotating about said booms,
each of said horizontally rotating portions are further capable of sliding up and down said booms to adjusting their relative heights,
each of said vertically rotating portions, having an inner portion and an outer portion, are attached to said horizontally rotating portions at one end of said inner portions,
said outer portions of said vertically rotating portion are capable of adjustably rotating about said inner portions, and
said nozzles are each attached to one of said outer portions.

16. The fogging system of claim 13 where said air tank is capable of replacing said base by attaching said compressed air source, said container, and said booms to said air tank rather than said base.

17. The fogging system of claim 13 wherein
said booms with said nozzle assemblies are capable of detaching from said base and capable of being carried to a treatment location; and
said chemical lines and said pressure hoses are sufficiently long to reach said treatment location.

18. The fogging system of claim 17 further comprising a fluid pump fluidly connected between said container and said nozzle assemblies capable of ensuring sufficient flow of said chemical to said treatment location.

19. A method for spraying a fog comprising
fluidly connecting an air source to an air tank in a compressor line,
compressing and pressurizing a compressed air in said air source,
collecting said compressed air in said air tank,
fluidly connecting said air tank to one or more nozzles with one of one or more pressure hoses,
regulating an air flow of said compressed air between said air tank and said nozzles,
fluidly connecting a container, containing a chemical, to said nozzles with one of one or more chemical lines,
regulating a chemical flow of said chemical between said container and said nozzles,
mixing said chemical and said compressed air in said nozzles, and
ejecting said chemicals and said compressed air from a nozzle output in said nozzles.

20. The method for spraying a fog of claim 19 further comprising
using an air compressor as said air source.

21. The method for spraying a fog of claim 19 further comprising
mixing said chemical and said compressed air in one or more Venturi nozzles each having a nozzle output, and
ejecting said chemicals and said compressed air from said nozzle output in said Venturi nozzles.

22. The method for spraying a fog of claim 19 further comprising
Regulating said air flow between said air tank and said nozzles with one or more pressure regulators.

23. The method for spraying a fog of claim 19 further comprising
regulating said chemical flow between said container and one or more of said nozzles with
one or more solenoid valves each connected to a controller and
one or more flow regulator assemblies each having a filter and a flow restrictor plate.
